(19) United States
(12) Patent Application Publication
(10) Pub. No.: US 2011/0029351 A1
(43) Pub. Date: Feb. 3, 2011

(54) Systems and Methods for Providing Compliance Functions in a Business Entity

(75) Inventors: Andreas Intemann, Mauern (DE); Dominic Kerner, Munchen (DE); Thomas Knobloch, Munchen (DE); Robert Söllner, Erlangen (DE); Carsten Thiel von Herff, Bad Homburg (DE)

Correspondence Address: King & Spalding LLP, 401 Congress Avenue, Suite 3200, Austin, TX, 78701, US

(73) Assignee: Siemens AG

(21) Appl. No.: 12/533,813

(22) Filed: Jul. 31, 2009

(51) Int. Cl. G06Q 10/00; G06N 5/02; G06F 17/30

(52) U.S. Cl. 705/9; 705/7; 706/50; 707/E17.014; 707/E17.005

(57) ABSTRACT

In some embodiments of the present disclosure, a system for providing compliance functions in a business entity is provided. The system includes a computer-implemented compliance question-answer tool configured to receive compliance related questions from a plurality of users and, in response, provide compliance related advice to the users; a computer-implemented compliance knowledge database tool including a database of compliance related data and a user interface allowing the users to search the database of compliance related data; and a computer-implemented user feedback tool including a user interface allowing the users to provide compliance related feedback to the business entity. In some embodiments, the system may also include a whistleblower tool including a user interface allowing the users to report potential compliance violations and/or a compliance activity approval tool configured to document and track activities that require an approval by a compliance entity.

### TECHNICAL FIELD

The present disclosure relates to systems and methods for providing compliance functions in a business entity.

### BACKGROUND

As businesses entities become larger and more complex, coupled with the rise of globalization and complex international business relationships, as well as recent legal mandates (e.g., Sarbanes-Oxley Act requirements), compliance issues have become more and more critical to businesses. Business entities must therefore provide a variety of compliance related functions. Current systems for providing, managing, and monitoring such compliance related functions are typically ad hoc and non-uniform across a business entity and over time.

### SUMMARY

In some embodiments of the present disclosure, a system for providing compliance functions in a business entity is provided. The system includes a computer-implemented compliance question-answer tool configured to receive compliance related questions from a plurality of users and, in response, provide compliance related advice to the users; a computer-implemented compliance knowledge database tool including a database of compliance related data and a user interface allowing the users to search the database of compliance related data; and a computer-implemented user feedback tool including a user interface allowing the users to provide compliance related feedback to the business entity.

In some embodiments of the present disclosure, a computer facilitated method for providing compliance functions in a business entity is provided. The method includes receiving a question from a requester via a communications network; generating a ticket for the question; routing the ticket to a question manager; the question manager reviewing the ticket and determining whether one or more subject matter experts need to be consulted for answering the question; at least one of the question manager and one or more subject matter experts preparing an answer to the question; approving the prepared answer; and forwarding the approved answer to the requester.

In some embodiments of the present disclosure, a computer facilitated method for providing compliance related feedback to a business entity is provided. The method includes receiving a feedback item from a submitter via a communications network; generating a ticket for the feedback item; routing the ticket to a question manager; the question manager reviewing the ticket and determining whether one or more subject matter experts need to be consulted for preparing an answer; at least one of the question manager and one or more subject matter experts preparing an answer; determining a risk profile for the ticket; automatically determining an appropriate party for reviewing the prepared answer; approving the prepared answer; and forwarding the approved answer to the submitter.

### BRIEF DESCRIPTION OF THE DRAWINGS

Some embodiments of the disclosure may be understood by referring, in part, to the following description and the accompanying drawings wherein:

FIG. 1 illustrates a system including a compliance helpdesk for providing compliance functions in a business entity, according to an example embodiment of the present invention;

FIG. 2 illustrates an example process flow for a compliance question-answer tool of the compliance helpdesk, according to certain embodiments of the present invention;

FIGS. 3A-3C illustrate a more detailed example of a question and answer process flow facilitated by the compliance question-answer tool, according to certain embodiments of the present invention;

FIG. 4 illustrates an example process flow for a whistleblower tool of the compliance helpdesk, according to certain embodiments of the present invention;

FIG. 5 illustrates a general overview of a compliance knowledge database tool of the compliance helpdesk, according to certain embodiments of the present invention;

FIG. 6 illustrates a more detailed example of a process flow for managing documents or other content maintained by the compliance knowledge database tool, according to certain embodiments of the present invention;

FIG. 7 illustrates an example process flow for a compliance feedback tool of the compliance helpdesk, according to certain embodiments of the present invention;

FIGS. 8A-8D illustrate a more detailed example of a compliance related feedback process flow facilitated by a compliance feedback tool of the compliance helpdesk, according to certain embodiments of the present invention;

FIG. 8E illustrates an example risk profile matrix for determining an appropriate party for approving an answer to a compliance feedback ticket, according to certain embodiments of the present invention;

FIG. 9 illustrates an example process flow for a compliance activity approval tool of the compliance helpdesk, according to certain embodiments of the present invention;

FIGS. 10A-10D illustrate a more detailed example of a compliance approval process flow facilitated by the compliance activity approval tool, according to certain embodiments of the present invention.

### DETAILED DESCRIPTION OF THE DRAWINGS

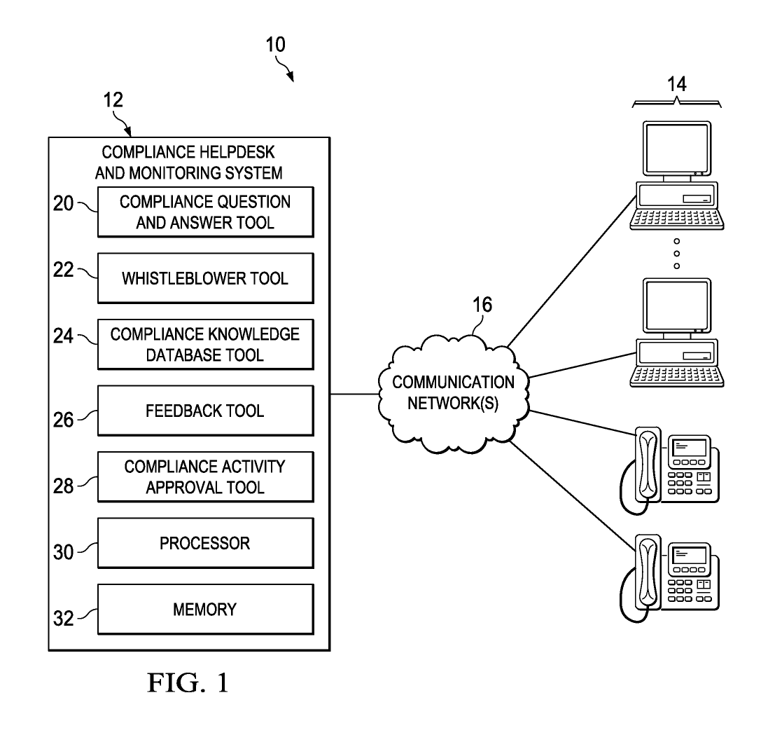

Selected embodiments of the disclosure may be understood by reference, in part, to FIGS. 1-10, wherein like numbers refer to same and like parts. The present disclosure is broadly concerned with systems and methods for providing compliance functions in a business entity. More particularly, an integrated computer-facilitated system for providing a variety of different compliance related functions is provided. For example, a system may include any combination of some or all of: (a) a question-answer tool for providing users (e.g., employees) answers to compliance related questions, (b) a compliance knowledge database tool allowing users to search for compliance related data, (c) a user feedback tool allowing users to provide compliance related feedback, ideas, suggestions, etc. to the business entity, (4) a whistleblower tool allowing users to report potential compliance violations and/or illegal activity, and (5) a compliance activity approval tool for documenting and tracking activities (e.g., gifts and hospitalities) that require an approval by a compliance entity.

Each of these various tools of the integrated compliance system may be partially or fully computer-implemented and/or automated. For example, the compliance knowledge database tool may be fully automated for a user (e.g., employee) such that the user may log into the tool and search a database for compliance related information without requiring action by another person. Some tools may include or require human action. For example, the question-answer tool may include experts for answering users' questions. For instance, the question-answer tool may include a web-based interface for receiving a compliance related question from a user (e.g., employee). The question may then be reviewed and routed (e.g., by a dispatcher and/or question manager) to an appropriate subject matter expert. The subject matter expert may then provide a response to the user's question, which may be forwarded back to user via the web-based interface or in another manner.

FIG. 1 illustrates a system 10 for providing compliance functions in a business entity, according to an example embodiment of the present invention. System 10 may include an integrated compliance helpdesk 12 configured to provide various compliance functions to a plurality of users at user devices 14 via one or more communications networks 16.

Compliance helpdesk 12 may include a compliance question-answer tool 20, a whistleblower tool 22, a compliance knowledge database tool 24, a compliance feedback tool 26, and a compliance activity approval tool 28.

Compliance question-answer tool 20 offers employees of the business entity the opportunity to ask questions regarding compliance entity at legal advice. Compliance question-answer tool 20 allows employees to submit compliance related questions, and receive answers from appropriate subject matter experts. Compliance question answer tool 20 may provide transparency and documentation of questions and answers, reliable compliance support for all employees of the business entity, a single point of contact for compliance related questions, automatic tracking and written documentation, and/or sustainable and traceable information storage. In some embodiments, compliance question answer tool 20 includes a first web-based user interface allowing employees to submit questions and receive answers from subject matter experts, and a second web-based user interface allowing the subject matter experts to receive questions submitted by employees and to enter responses to be forwarded back to the appropriate employees.

Whistleblower tool 22 is provided to allow employees to report potential compliance violations and/or illegal activity. For example, whistleblower tool 22 may provide a standardized and secure process for handling accusations regarding noncompliant behavior companywide, and in particular, may assist with fulfillment of legal requirements of the Sarbanes Oxley Act. Whistleblower tool 22 may comply with legal and or company defined data security and data protection requirements, and may be integrated into a legal and investigation workflow of the business entity. Whistleblower tool 22 may include a phone-based and/or web-based whistleblower hotline accessible to employees. For example, whistleblower tool 22 may provide a worldwide or companywide 24/7 available whistleblower hotline with multiple languages provided by an independent service company but integrated into a compliance legal and compliance investigations workflow of the business entity.

Compliance knowledge database tool 24 is provided to allow employees to search one or more databases of compliance related data. For example, such databases may include an overview of companywide policies and guidelines (thus providing transparency and review and debureaucratization), a collection of compliance solutions (e.g. FAQ), a collection of best practices, and/or statistic compliance reporting. Thus, database tool 24 may provide “one-stop shopping” of compliance know-how, thus facilitating knowledge building and sharing companywide. Database tool 24 may include a web-based user interface allowing employees to access the compliance related databases.

Compliance feedback tool 26 allows employees to provide compliance related feedback, ideas, suggestions, etc. to the business entity. Such feedback may be used, for example, to continuously improve the business entity's compliance organization in program. This improvement process may be integrated into the other tools and/or processes of compliance helpdesk 12. Compliance feedback tool 26 may include a web-based user interface allowing employees to provide feedback.

Compliance activity approval tool 28 may provide a tracking tool for documenting and tracking activities (e.g., gifts and hospitalities) that require an approval by a compliance organization of the business entity, according to legal requirements and/or guidelines of the business entity. For example, compliance activity approval tool 28 may provide central documentation for gifts and hospitality release, worldwide or business wide tracking and controlling, and/or compliance support for compliance officers and employees companywide. Such functions may also facilitate acceleration of the approval process.

Each tool of compliance helpdesk 12 (including compliance question-answer tool 20, whistleblower tool 22, compliance knowledge database tool 24, compliance feedback tool 26, and compliance activity approval tool 28) is at least partially embodied in software or other logic instructions embodied in memory 32 and executable by one or ore processors 30 to provide the various functions discussed herein. A processor 30 may comprise any system, device, or apparatus operable to interpret and/or execute software or program instructions and/or process data associated with compliance helpdesk 12, and may include, without limitation, a microprocessor, microcontroller, digital signal processor (DSP), application specific integrated circuit (ASIC), or any other digital or analog circuitry. In particular, processor(s) 30 may interpret and/or execute program instructions and/or process data stored in memory 32 and/or another component of compliance helpdesk 12.

Memory 32 may be communicatively coupled to processor 30 and may include any computer-readable media suitable for storing any data or logic associated with compliance helpdesk 12. For example, memory 32 may include computer-readable media for storing data and logic instructions associated with compliance question-answer tool 20, whistleblower tool 22, compliance knowledge database tool 24, compliance feedback tool 26, and/or compliance activity approval tool 28. For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; and/or any combination of the foregoing.

User devices 14 may include any one or more types of computerized devices that may provide a user an interface for communicating with compliance helpdesk 12 via one or more communications networks 16. For example, user devices 14 may include one or more desktop computers, workstations, laptop computers, personal digital assistants (PDAs), telephones (land lines and/or cellular phones), etc. Each user device 14 may include any suitable hardware (e.g., processors, memory, software, and input and output (I/O) devices (e.g., a keyboard, a mouse, and a video display) and any suitable software and/or firmware (e.g., a web browser application) for interacting with compliance helpdesk 12.

Communications networks 16 may include any one or more types of networks and/or fabrics configured to user devices 14 to compliance helpdesk 12. Networks 16 may include one or more of a storage area network (SAN), personal area network (PAN), local area network (LAN), a metropolitan area network (MAN), a wide area network (WAN), a wireless local area network (WLAN), a virtual private network (VPN), an intranet, the Internet, plain old telephone service (POTS) analog lines, integrated services digital network (ISDN) lines, or any other appropriate architecture or system that facilitates the communication of signals, data and/or messages (generally referred to as data) user devices 14 to compliance helpdesk 12. Network 16 may transmit data using wireless transmissions and/or wire-line transmissions via any storage and/or communication protocol. Network 16 and its various components may be implemented using hardware, software, or any combination thereof.

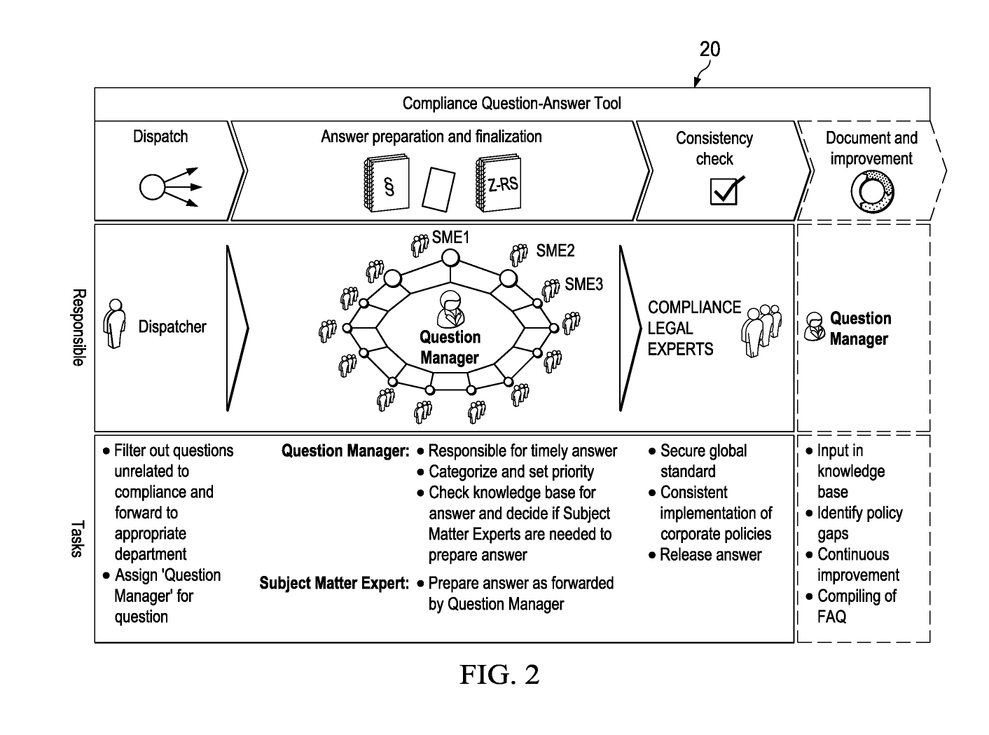

FIG. 2 illustrates an example process flow for compliance question-answer tool 20, according to certain embodiments of the present invention. The top portion of FIG. 2 illustrates the various phases of the compliance question answer process: dispatch, answer preparation and finalization, consistency check, and document and improvement. The middle portion of FIG. 2 illustrates the responsible parties for each of the process phases. One or more dispatchers are responsible for the dispatch phase, one or more question manager's and subject matter experts (SMEs) are responsible for the answer preparation and finalization phase, one or more compliance legal entities (CLs) are responsible for the consistency check phase, and one or more question managers are responsible for the document and improvement phase.

The bottom portion of FIG. 2 illustrates the tasks involved in each of the phases of the compliance question answer process, described as follows. A dispatcher may receive questions from employees (e.g., submitted by the employees using a web-based interface and communicated to the dispatcher via communications network 16). The dispatcher may filter out questions unrelated to compliance and forward such filtered questions to their appropriate departments of the business entity. The dispatcher may then forward the compliance related questions to one or more question managers. In some embodiments, the system includes a single question manager who receives all employee questions forwarded from the dispatcher. In other embodiments, the system includes multiple question managers, who may be assigned to different organizational units within the business entity, different types of questions, different geographic regions, or otherwise assigned. In such embodiments, the dispatcher may forward each compliance related question to the appropriate question manager based on the respective assignments of the question managers.

As shown at the bottom portion of FIG. 2, a question manager may be responsible to review incoming employee questions and categorize and/or set priorities for such questions accordingly. For a pending employee question, the question manager may search for an answer and decide whether a SME (or multiple SMEs) are needed to prepare an answer. For example, the question manager may utilize compliance knowledge database tool 24 to search one or more compliance related databases to find an answer to the employee question, and if unsuccessful, may forward the question to one or more appropriate SMEs.

After receiving an employee question forwarded from the question manager, a subject matter expert may prepare a full or partial answer by accessing any suitable sources and/or expert knowledge. The system may include various different types of SMEs (illustrated as SME1, SME2, SME3, etc. in FIG. 2), such as, for example, a compliance officer, a tax expert, various legal experts, a Sarbanes-Oxley expert, and OSHA expert, and/or any other types of subject matter experts in a business entity. After preparing an answer, the subject matter expert may then forward the answer to the question manager, who may finalize the answer and forward the finalized answer to an appropriate compliance legal expert (CLE) for the consistency check phase, as shown in FIG. 2. The system may include a single CLE or multiple CLEs assigned by organizational unit, area of expertise, geographic region, or otherwise assigned. Upon receiving an answer forwarded by an SME, a CLE reviews the answer to ensure consistent implementation of the business entity's policies, in order to secure a global or business wide standard. If the CLE approves the consistency of the answer, the CLE releases the answer for forwarding back to the requesting employee. If the CLE rejects the consistency of the answer, the CLE may return the answer to the question manager with an indication of the inconsistency or problem with the answer, such that the question manager can revise the answer as appropriate.

After the answer has been released to the requesting employee, a question manager (which may or may not be the same question manager that previously handled the question) may then perform the document and improvement phase of the process. This may include entering the question and answer exchange into one or more appropriate databases of compliance knowledge database tool 24 (e.g., a FAQ database), such that this question and answer exchange may now be accessible to all employees and question managers.

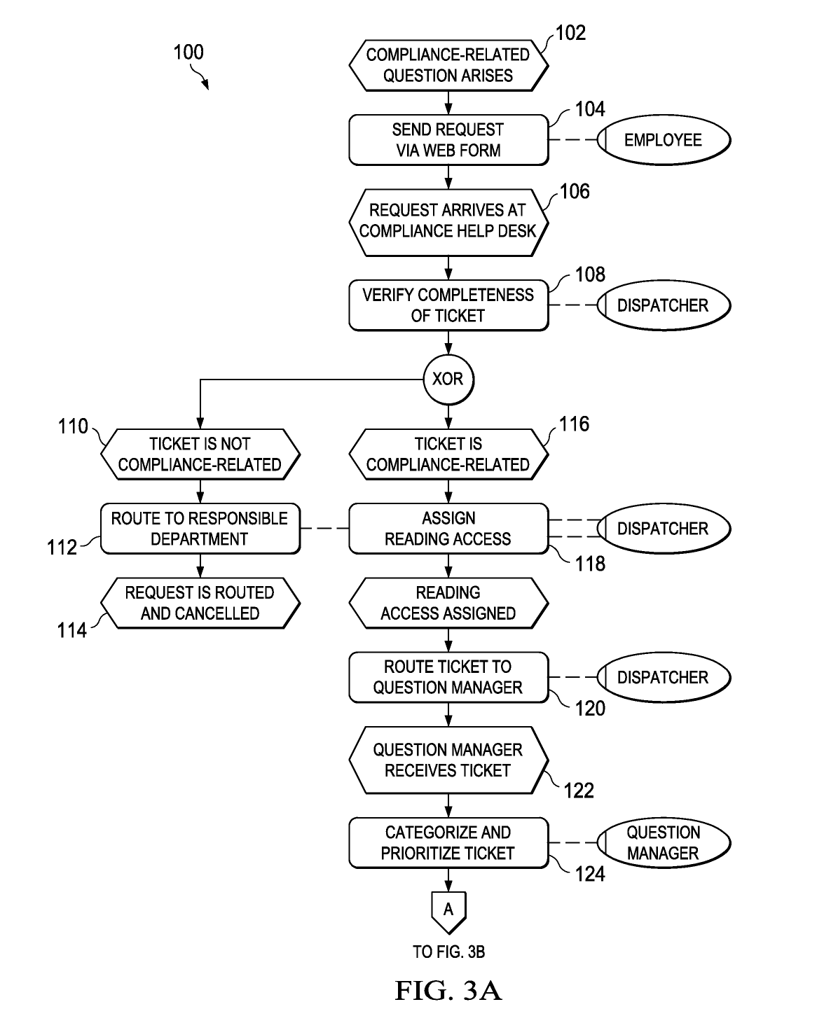

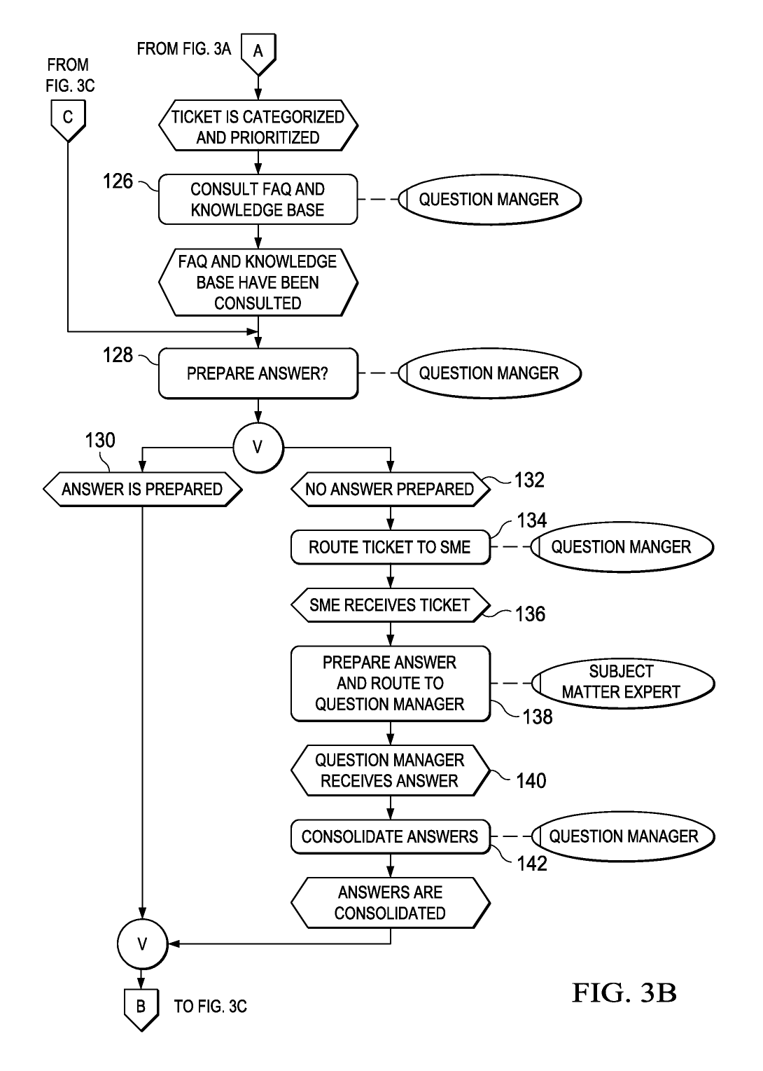

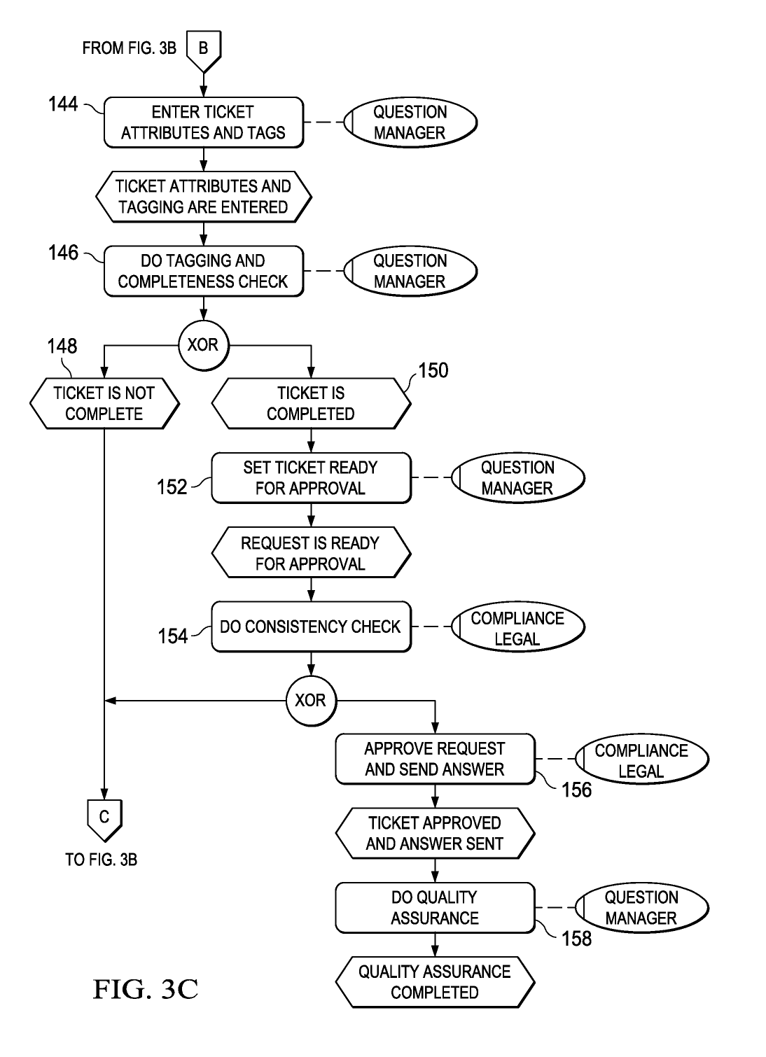

FIGS. 3A-3C illustrate a more detailed example of a question and answer process flow 100 facilitated by compliance question-answer tool 20, according to certain embodiments of the present invention. FIGS. 3A-3C illustrate the various steps of process flow 100, as well as the person or entity that performs each step, as indicated in the ovals to the right of the process flow steps.

At step 102, a compliance related question arises. At step 104, an employee using user device 14 sends a request (e.g., question) via a web-based form provided by compliance question and answer tool 20. For example, the employee may enter his or her compliance related question into a specific compliance question web form on an intranet page provided by compliance helpdesk and monitoring system 12. In some embodiments, statements made by the employee are treated as confidential and processed under the terms of any relevant data protection laws.

At step 106, the request is communicated via education network 16 and arrives at compliance helpdesk system 12. In particular, the request may be displayed to a dispatcher by an intranet page provided by compliance question and answer tool 20. At step 108, the dispatcher may verify the completeness of the request ticket. The dispatcher may then determine whether the request ticket is compliance related. If the request ticket is not compliance related, indicated at step 110, the dispatcher may use tool 20 to route the request ticket to an appropriate responsible department at step 112, and cancel the request ticket from the compliance system at step 114. Tool 20 may automatically send a notification to the requesting employee, indicating that the request was not compliance related and thus routed to the responsible department outside of compliance helpdesk 12.

Alternatively, if the request ticket is compliance related, indicated at step 116, the dispatcher may assign reading access to the request ticket to one or more appropriate persons in the business entity at step 118. For example, the dispatcher may use tool 20 to assign reading access to a regional compliance officer (RCO) or division compliance officer (DCO) depending on the requesters country of origin or the sector/division here she works for. After reading access is assigned, the dispatcher uses tool 20 to route the request ticket to an appropriate question manager at step 120. In embodiments including multiple question managers assigned to different organizational units, types of questions, geographic regions, etc., the dispatcher may select an appropriate question manager based on the details of the request ticket, and use tool 20 to forward the request ticket to the selected question manager.

At step 122, the request ticket may be displayed to the question manager by an intranet page provided by tool 20. At step 124, the question manager categorizes and prioritizes request ticket in relation to other pending tickets that have been forwarded to that question manager. After the request ticket is categorized and prioritized, the question manager may interact with compliance knowledge database tool 24 to search for an answer to the question, at step 126. For example, the question manager may search for a sample answer available in the FAQs maintained by tool 24.

Based on the results of the question managers research, the question manager may determine at step 128 whether he or she can prepare an answer independently (i.e., without having to route the ticket to a subject matter expert). If the question manager is able to prepare an answer independently, the question manager prepares the answer at step 130. If not, indicated at 132, the question manager uses tool 20 to select and route the request ticket to one or more appropriate subject matter experts (SMEs) based on the subject matter of the request, at step 134. For example, if the system includes various different types of SMEs, e.g., one or more compliance officers, tax experts, legal experts, etc., the question manager may route the request ticket to one or more of these SMEs based on the topic(s) relating to the particular request ticket, as identified by the question manager.

In some embodiments, tool 20 may route the request ticket by e-mail to each SME selected by the question manager. At step 136, the request ticket may be received by each SME selected by the question manager. At step 138, each SME may prepare a complete answer regarding the topic he or she is responsible for, and return the answer to the question manager, e.g., by email. In some embodiments, selected types of SMEs may, at their discretion, involve one or more additional subject matter experts in forming their answer. For example, a first SME may solicit additional information from a second SME (who may or may not have been selected by the question manager) by e-mail. The first SME may then incorporate information received from the second SME into his or her reply, and forward the answer back to the question manager, e.g., by e-mail.

At step 140, the question manager receives the answers from each of the SMEs to which the request ticket was forwarded at step 134. At step 142, the question manager consolidates the answers from the SMEs and verifies their accuracy and consistency.

At step 144, the question manager may enter (e.g., select) ticket attributes and tags into tool 20. At step 146, the question manager may check the completeness of the ticket, including verifying that an answer has been formulated, ticket attributes have been set, tagging has been carried out, correct access rights have been given, and that a corresponding compliance officer has been identified for receiving a copy of the answer to be forwarded (e.g., by an intranet page or by e-mail) to the requesting employee. If the ticket is not complete, indicated at 148, the method returns to step 128, for the question manager to either prepare an answer independently or resubmit the ticket request to one or more SMEs. If the ticket is complete, indicated at 150, the question manager may then route the ticket to a compliance legal entity (e.g., by an intranet page or by e-mail) for approval at step 152. For example, the compliance legal entity may include a number of attorneys assigned to different topics, and the question manager may select a responsible attorney assigned to the topic associated with the ticket.

At step 154, the responsible attorney may perform a consistency check, which may include, for example:
Does the answer contain a short summary of the facts the way the question manager/SMEs understood the requester's question?
Does the answer contain an explanation/reference to the policies on which the decision is based?
Is the answer consistent with effective policies and guidelines?
Is the answer compliant with a set of business conduct guidelines?
Have local law or policies been considered in the final answer?
Does the answer match the companywide or global standard?
Have all documents, relevant for the decision finding process, been attached to the answer (e.g., attached to an e-mail including the answer)?
Has the whole question been answered?
Does the answer include an explanation why the question manager/SMEs answered the request in the way it was answered?

If the responsible attorney does not approve the consistency check, the method returns to step 128, for the question manager to either prepare an answer independently or resubmit the ticket request to one or more SMEs. If the responsible attorney does approve the consistency check, the responsible attorney approves the answer and forwards the answer to the requesting employee (e.g., by an intranet page or by e-mail) at step 156. At step 158, the question manager may perform a quality assurance analysis, including reviewing the process ticket and deciding if the question is of general interest. If so, the question manager may label the question as FAQ-relevant in the ticket attributes such that tool 20 may automatically add the ticket to the set of FAQs maintained by compliance knowledge database tool 24.

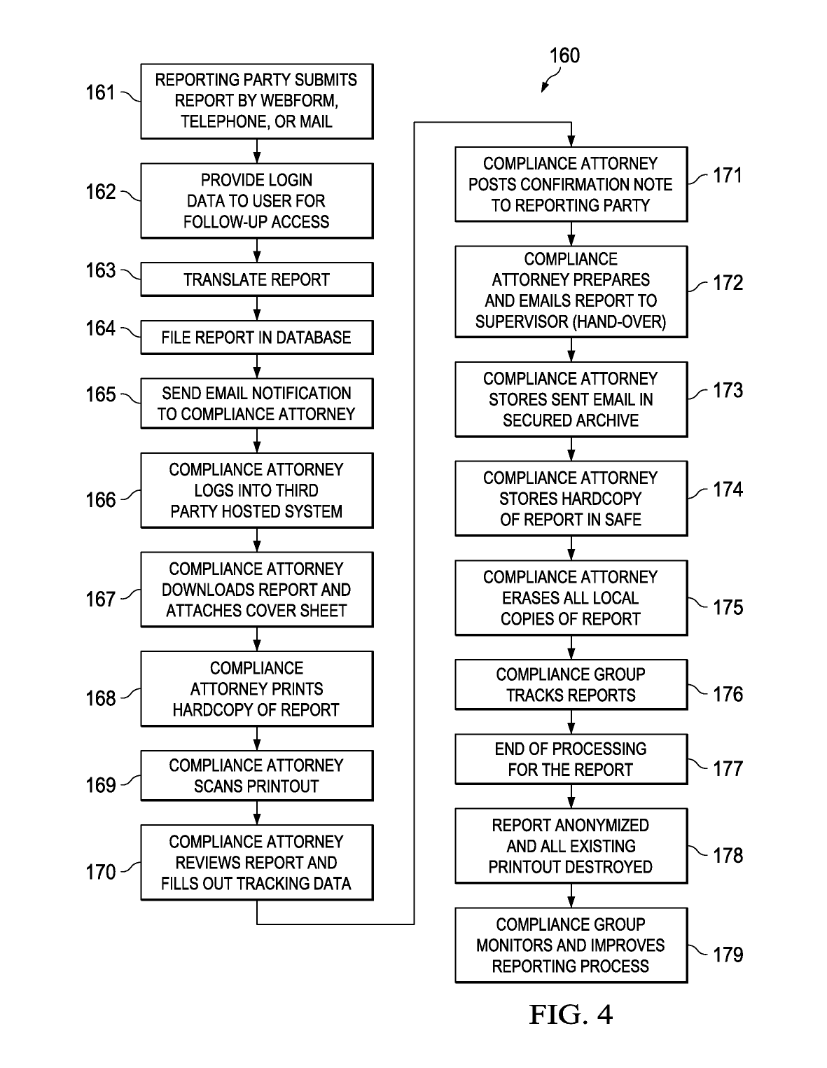

FIG. 4 illustrates an example process flow 160 for whistleblower tool 22, according to certain embodiments of the present invention. At step 161, a reporting party (e.g., an employee of the business entity) submits a report regarding a potential compliance violation or illegal activity by the business entity (hereafter referred to as a “PCV report”). The entry point for all PCV reports (whether anonymous or named) is a webform-system hosted and maintained by an independent third-party relative to the business entity, e.g., EthicsPoint, Inc. having a location at 600 Meadow Road, Suite 200, Lake Oswego, Oreg., 97035. This third-party host may take up and register PCV reports in a report database under guarantee of confidentiality and data privacy, and may remain uninvolved in any internal investigations regarding any PCV reports. The guarantee of confidentiality and data privacy may be confirmed by a contract between the business entity and the third-party host. In some embodiments, the third-party host may hold a “safe harbor” certification by the U.S. Department of Commerce.

The reporting party can enter a PCV report is three different ways. First, the reporting party can enter a PCV report directly into an internet webform available to the reporting party at user device 14, e.g., by a third-party application accessible via user device 14. In this case, the reporting party may file the report him or herself into the fields provided by the webform. The webform may include a detailed data privacy statement. Second, the reporting party can enter a PCV report via a telephone call to a call center of the third-party host. At the start of the conversation, the call center employee of the third-party host may inform the reporting party about the data privacy statement. If the reporting party has not read the statement or needs to be informed about the contents of the data privacy statement, the call center employee informs him or her via a standardized statement about the data privacy background and his or her respective rights. The reporting party may then provide his or her PCV report verbally to the call center employee. The call center employee files the PCV report without alterations into the report database. Third, the reporting party can file a PCV report by written mail. In this case, an employee of the third-party host reviews the written PCV report and files the enclosed data into the report database. The original PCV report documents are scanned and attached to the report. The manner in which the PCV report is entered (by webform, telephone, or mail) does not have any further influence on the report. The following process therefore does not differentiate between the three manners of entering the report.

At step 162, the reporting party is provided login-data to access his or her particular PCV report in the third-party application for follow-ups and status checks. In one embodiment, the business entity does not have access to these login data, but can see whether and when the reporting party accessed the PCV report.

At step 163, the PCV report may be translated. The third-party host may translate the PCV report itself, or use a translation service provider, e.g., depending on the particular language of the PCV report. The translation is then added to the PCV report.

At step 164, the third-party host then files the PCV report in a database maintained by the third-party host. Except for personnel explicitly designated in this process, the business entity has no access to the third-party database system. All access to the database system is logged by the third-party host, and the business entity cannot change or review these logs.

Once the PCV report is files the third-party hosted database, the third-party system may automatically notify one or more compliance members (e.g., compliance officers or compliance attorneys) of the business entity by an email indicating the newly filed report at step 165. The third-party system may notify the compliance members via email about new PCV reports, new files, and follow-up actions. These notification mails do not contain any information on the respective PCV report or the reporting party other than a system ID of the report.

At step 166, a compliance member of the business entity (e.g., compliance officer or compliance attorney) may log into the third-party system in order to access the PCV report, e.g., by logging into the third-party application via a user device 14. This access is logged by the third party system, and the business entity cannot block or circumvent this logging. Logging into the third party system may be a two-step process requiring dual authentication. The first step is a remote access login to the third-party host, which requires the compliance member to enter a first username and first password (e.g., using an RSA token and additional member-specific PIN). The first username and RSA-Token are provided by the third party host, and the business entity has no means to administrate these settings. The second step is a client login, which requires the compliance member to enter a second username and second password, which are assigned by the compliance group of the business entity via an administration tool provided by the third party system.

At step 167, the compliance member downloads the PCV report into a word processing application and attaches a dated cover-sheet. The compliance member chooses a name for the PCV report to distinguish the report from other reports. The report name must not contain any privacy-sensitive data. At step 168, the compliance member prints out one hardcopy of the PCV report. At step 169, the compliance member scans the printout.

At step 170, the compliance member reviews the PCV report contents and fills out various statistical tracking fields in the system, as far as such information is available. Example statistical tracking fields include data regarding the source of the report (e.g., business entity sector, division, country, group, etc.), an issue topic, an assigned compliance member, the decision on the report, and a classification of the report.

At step 171, the compliance member posts a follow-up confirmation note to the reporting party. This note is only readable within the system, i.e. the reporting party needs to login to the system and access his or her PCV report in order to read the note.

At step 172, the compliance member prepares the report for handover and emails the report to a supervisor (e.g., the head of the compliance group). For example, the compliance member may prepare an encrypted email, e.g., entitled “Tell us PCV report #-<Name>”, attach the report, add a short assessment and recommendation for further action, and send the email. After sending the mail, the compliance member may add a case note on the date of the handover and the identity of the recipient (supervisor). The assessment may include the following items of particular significance: relevance of the PCV report for an anti-corruption program of the business entity, responsibilities of particular personnel with respect to the reported issue, and possible legal implications of reported issue.

At step 173, the compliance member stores his or her copy of the sent email in a separate, secured archive (e.g., a .pst-archive) for all PCV report related emails. At step 174, the compliance member stores the hardcopy of the PCV report in a safe maintained by the compliance group, or in another designated secure area.

At step 175, the compliance member erases all local copies of the PCV report from his or her computer and network-drives. This may include erasing report-files with setting “DOD” (7 times overwrite), erasing temporary Internet- and email system files (e.g. “ . . . \OLK35”), and regularly (e.g., weekly) erasing unused disk space on local hard-drives.

At step 176, the compliance group tracks PCV reports. The compliance group may track hand-overs and feedback to the respective PCV reports as far as those are made known to the compliance group. In particular, a tracking-log may be maintained in third-party system, which may manage a status of each PCV report:
before hand-over to supervisor: status “unreviewed”
after hand-over to supervisor: status “reviewed”
after s mandate for investigation by supervisor: status “in process”
after feedback on the outcome of the investigation: status “resolved”
after anonymization (step 178): status “closed.”

In addition, the compliance group may regularly (e.g., every 15 days) review all PCV reports with the following parameters: (a) status of “reviewed” or “in process” or (b) “last modified” more than some predetermined time (e.g., 2 months) ago. In addition, the compliance group may regularly (e.g., every quarter) review all PCV reports with the following parameters: (a) status of “reviewed” or “in process” or (b) “date opened” more than some predetermined time (e.g., 8 months) ago.

At step 177, the end of processing for the PCV report is mandated by the responsible compliance member, who also specifies which information is given to the reporting party as feedback.

At step 178, within some predetermined time (e.g., 3 months) after end of processing (status “resolved”), the PCV report filed in the third party system is anonymized by the compliance group and all existing print-outs maintained by the compliance group are destroyed. After this, the status is set to “closed.” At this point, no PCV report personal-related data is maintained by the third party system or the compliance group.

At step 179, the compliance group monitors developments of incoming PCV reports and deducts tendencies and possible regulations, in order to continuously improve and enhance understanding of verified statistical effects. The monitoring may focus on, for example, (a) geographical distribution of incoming PCV reports, (b) internal distribution of incoming PCV reports, and (c) report sources (internal, external, anonymous, identified).

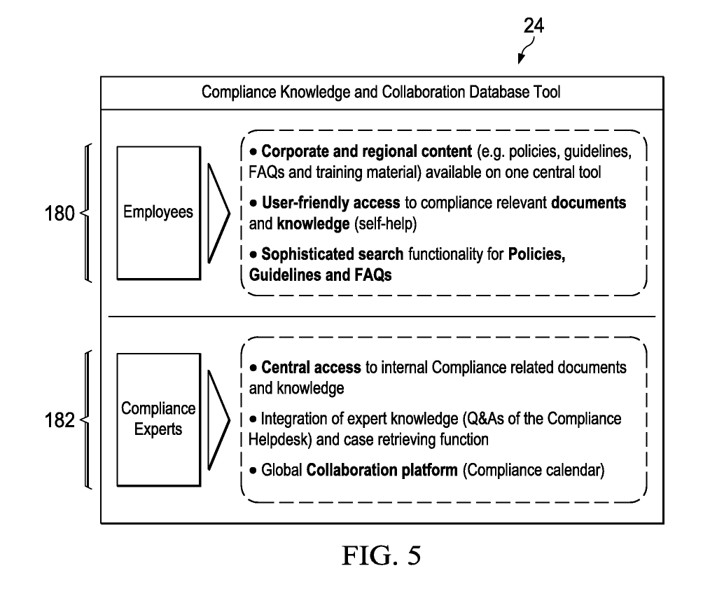

FIG. 5 illustrates a general overview of compliance knowledge database tool 24, according to certain embodiments of the present invention. As discussed above, database tool 24 allows employees to search one or more databases of compliance related data. For example, such databases may include an overview of companywide policies and guidelines (thus providing transparency and review and debureaucratization), a collection of compliance solutions (e.g. FAQ), a collection of best practices, and/or statistic compliance reporting. Database tool 24 may be accessible to employees via an intranet of the business entity.

As shown in FIG. 5, database tool 24 may include two main parts or areas: a public area (summarized at 180) and a restricted area (summarized at 182). The public area may be accessible to all employees of the business entity. The public area may contain all compliance related documents within the business entity, e.g., training documentation, circulars, guidelines, etc. Database tool 24 includes a sophisticated search engine to search for such compliance related information. For example, the search engine may allow employees to run the filtered searches according to selected parameters, such as type of document, country, language, etc.

The restricted area is accessible only to authorized persons, e.g., compliance officers or members of a defined compliance organization of the business entity. The restricted area may be a central collaboration platform for sharing knowledge and content within the defined compliance organization. The restricted area may be divided into sections or folders, each having an associated content owner, who was responsible for uploading the latest versions of documents to their respective sections or folders. The restricted area may also include a shared compliance calendar for managing relevant meetings and other events within the compliance organization.

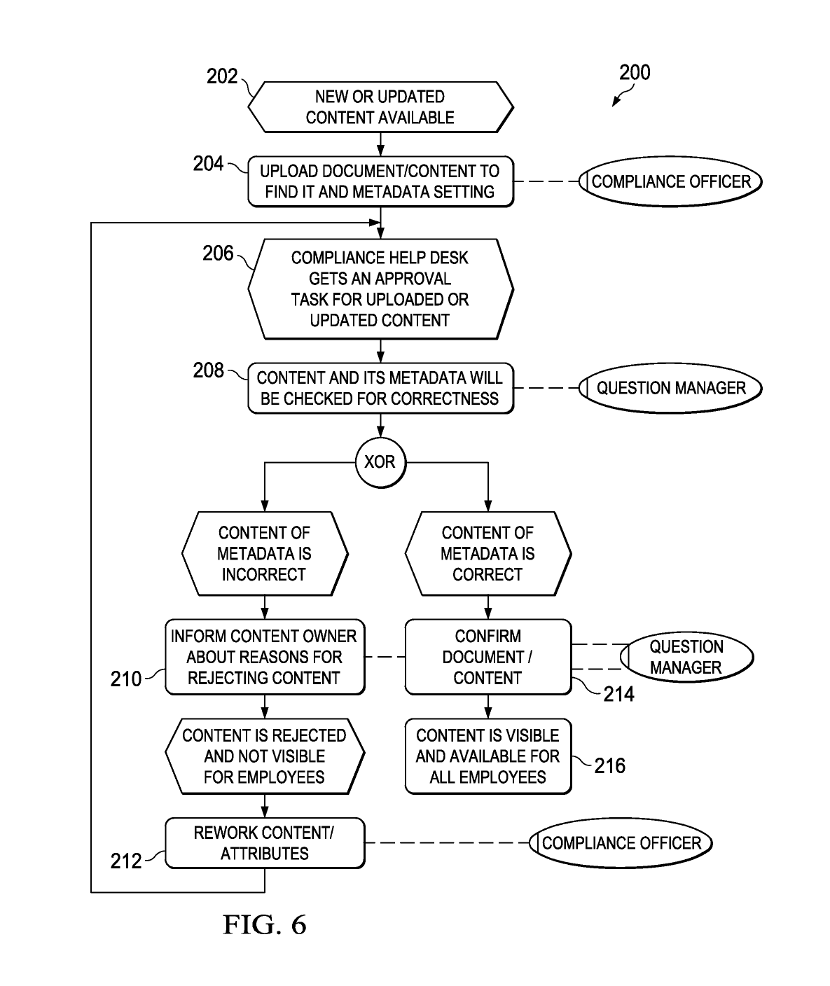

FIG. 6 illustrates a more detailed example of a process flow 200 for managing documents or other content maintained by compliance knowledge database tool 24, according to certain embodiments of the present invention. FIG. 6 illustrates the various steps of process flow 200, as well as the person or entity that performs each step, as indicated in the ovals to the right of the process flow steps.

At step 202, new or updated document/content becomes available to a compliance officer. At step 204, the compliance officer uploads the new or updated document/content in an upload area provided by database tool 24. Database tool 24 may prompts the compliance officer to select one or more appropriate metadata/attributes for the document/content to be uploaded. At step 206, the compliance helpdesk receives an approval task (ready for approval) in an approval task list provided by database tool 24. At step 208, a responsible question manager checks the content and the corresponding metadata for correctness, and makes appropriate changes (unless a major mistake is detected). The content is not visible to employees until the question manager approves it; before approval, the content is only visible to the question manager and the content owner/author.

If the question manager detects a major mistake (e.g., the document cannot be opened or significant metadata settings were not completed), the question manager rejects the content and enters reason(s) for the rejection at step 210. Database tool 24 then informs the content owner of the rejection, including the question manager's reason(s) for rejection, e.g., via an automatic e-mail. The content owner must then rework the content and/or the metadata settings in view of the reasons for rejection, as indicated at step 212.

Alternatively, if the question manager approves the content and metadata check, the question manager confirms the document/content for access by all employees at step 214. The approve content will then be automatically moved from the upload area two and employee access area such that the content is available to all employees companywide, as indicated at 216.

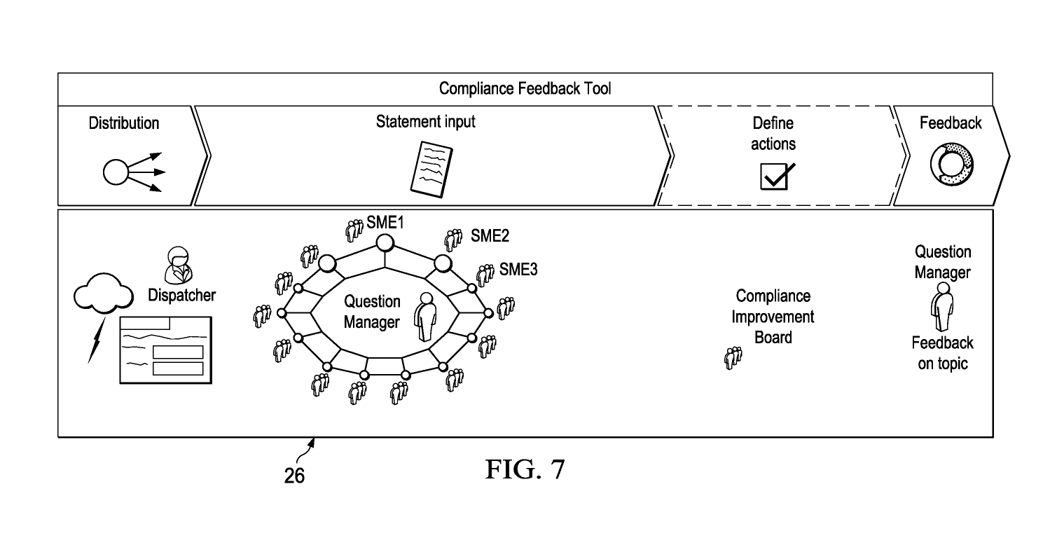

FIG. 7 illustrates an example process flow for compliance feedback tool 26, according to certain embodiments of the present invention. The top portion of FIG. 7 illustrates the various phases of an improvement feedback process: distribution, statement input, define actions, and feedback. The remaining portion of FIG. 7 illustrates the responsible parties and certain tasks associated with each phase of the improvement feedback process, which may be used for handling employee feedback such as complaints, ideas, and suggestions.

As shown in FIG. 7, to begin the improvement feedback process, a dispatcher receives a feedback ticket from an employee (e.g., submitted by the employee using a web-based interface and communicated to the dispatcher via communications network 16). The dispatcher may redirect the feedback ticket if it is unrelated to compliance. Otherwise, the dispatcher may forward the feedback ticket to an appropriate question manager. The question manager may determine whether the feedback ticket can be handled by the question manager him or herself, or by one or more subject matter experts (SMEs), or whether the feedback ticket must be forwarded to a compliance improvement board (CIB) for handling. After the feedback ticket is forwarded and answered by the appropriate entity, the ticket is forwarded to the head of compliance helpdesk 12 for approval. If the head of compliance helpdesk 12 approves the answer, the answer is then sent back to the employee who submitted the feedback ticket.

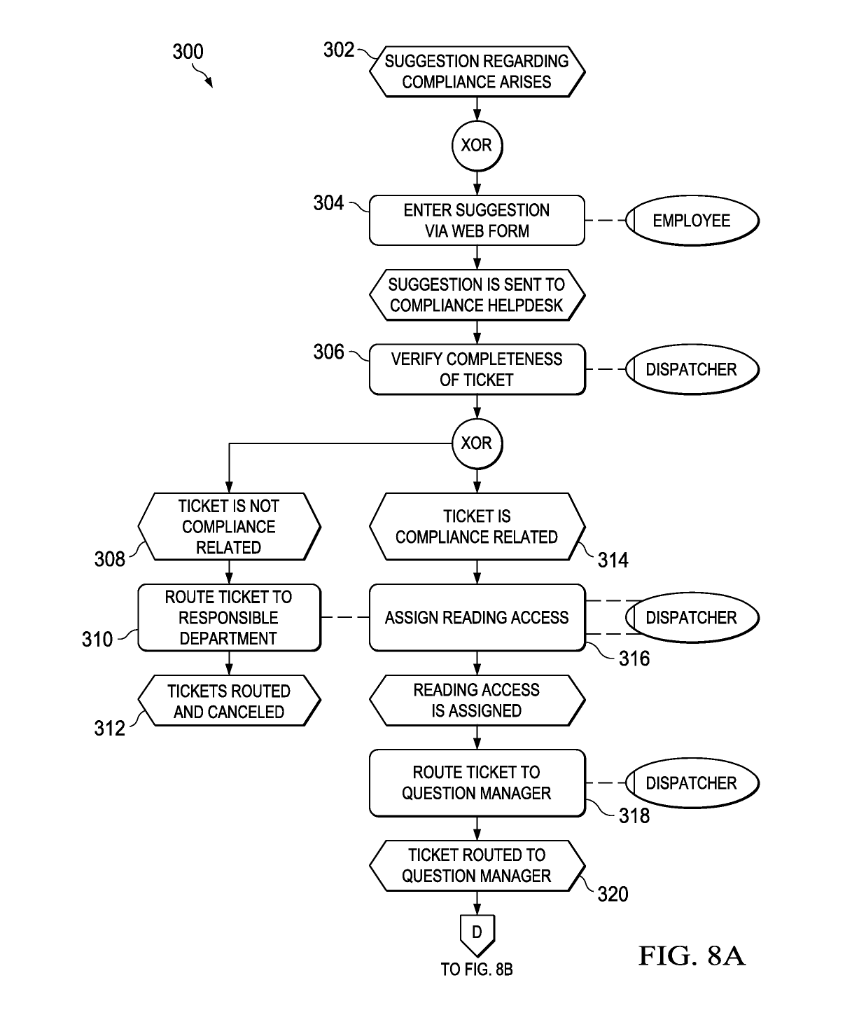

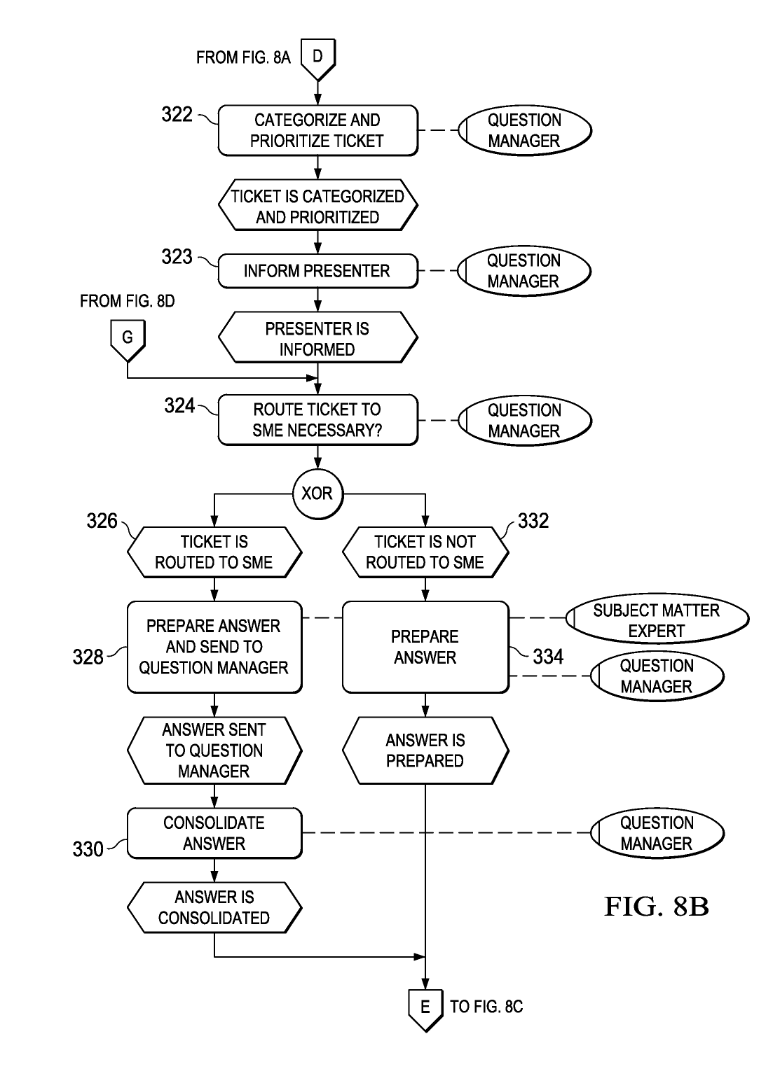

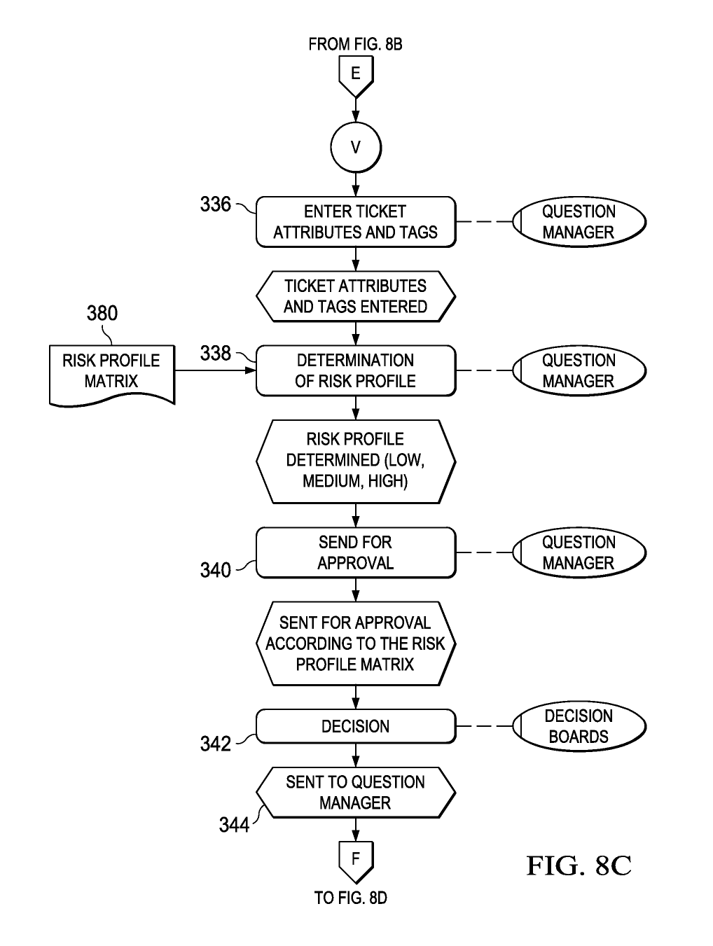

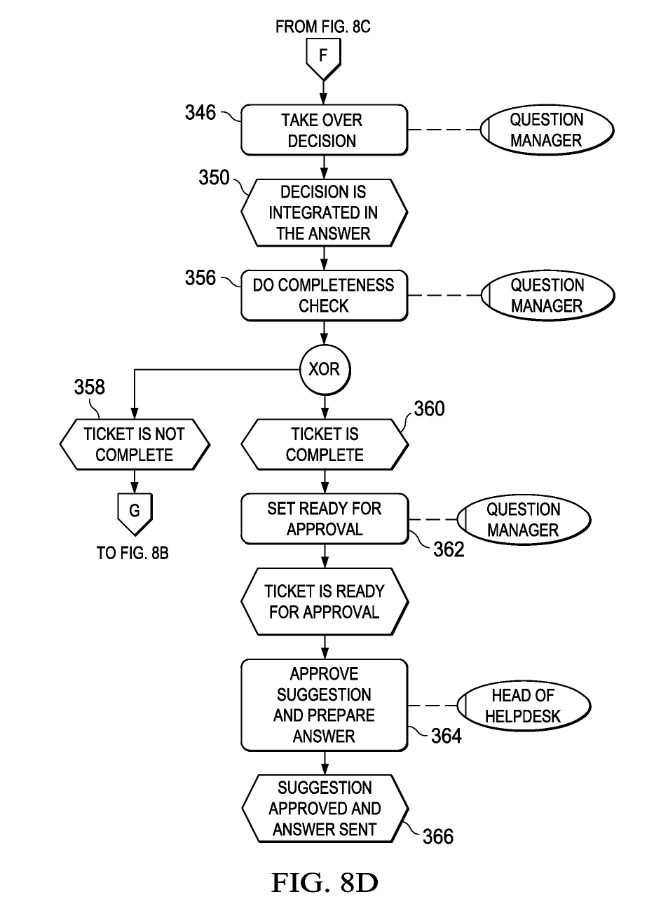

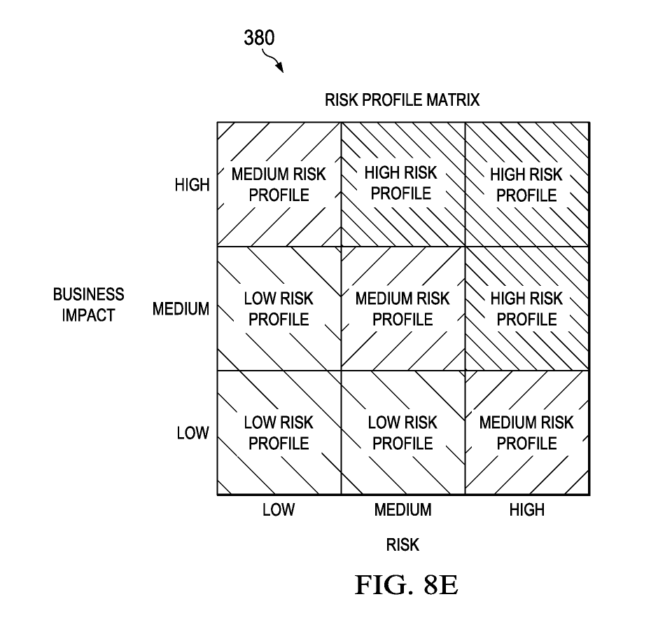

FIGS. 8A-8D illustrate a more detailed example of a compliance related feedback process flow 300 facilitated by compliance feedback tool 26, according to certain embodiments of the present invention. FIGS. 8A-8D illustrate the various steps of process flow 300, as well as the person or entity that performs each step, as indicated in the ovals to the right of the process flow steps.

At step 302, an employee of the business entity identifies compliance related feedback (e.g., a suggestion, idea, recommendation, review, etc.). At step 304, the employee enters the compliance related feedback into an intranet page provided by feedback tool 26, such that a feedback ticket is automatically forwarded to compliance helpdesk 12. At step 306, a dispatcher reviews and verifies the completeness of the feedback ticket, including determining whether the request ticket is compliance related. If the feedback ticket is not compliance related, indicated at 308, the dispatcher may use feedback tool 26 to route the feedback ticket to an appropriate responsible department at step 310, and cancel the feedback ticket from the compliance system at step 312. Tool 20 may automatically send a notification to the employee (referred to below as the “submitter”), indicating that the feedback was not compliance related and thus routed to the responsible department outside of compliance helpdesk 12.

Alternatively, if the feedback ticket is compliance related, indicated at step 314, the dispatcher may assign reading access to the feedback ticket to one or more appropriate persons in the business entity at step 316. For example, the dispatcher may use feedback tool 26 to assign reading access to regional compliance officers (RCOs), divisional compliance officers (DCOs), and/or sector compliance officers (SCOs) depending on the submitter's country of origin or the sector/division here she works for. After reading access is assigned, the dispatcher uses feedback tool 26 to route the feedback ticket to an appropriate question manager at step 318. In embodiments including multiple question managers assigned to different organizational units, types of questions, geographic regions, etc., the dispatcher may select an appropriate question manager based on the details of the feedback ticket, and use tool 26 to forward the feedback ticket to the selected question manager.

At step 320, the feedback ticket may be displayed to the question manager by an intranet page provided by feedback tool 26. At step 322, the question manager categorizes and prioritizes feedback ticket in relation to other pending tickets that have been forwarded to that question manager. After the feedback ticket is categorized and prioritized, the question manager may confirm receipt of the feedback ticket and inform the submitter of further process steps, e.g., by e-mail or telephone, at step 323.

At step 324, the question manager determines whether it is necessary to route the feedback ticket to one or more SMEs. If so, the feedback ticket is routed to one or more appropriate SMEs (e.g., via email) at step 326, each of whom prepares a complete answer regarding the topic he or she is responsible for and sends it back to the question manager (e.g., via email) at step 328. At step 330, the question manager then consolidates the answers (if the ticket was routed to multiple SMEs) and verifies the accuracy and consistency of the answers. If the question manager determines at step 324 that it is not necessary to route the feedback ticket to any SMEs, the feedback ticket is not routed to any SMEs (indicated at step 332), and the question manger prepares the answer him or herself at step 334.

Once the answer is prepared, the individual ticket attributes are set by the question manager at step 336. At step 338, the question manager then determines a risk profile (e.g., low, medium, or high) for the feedback ticket in alignment with the appropriate SME(s) with the aid of a risk profile matrix or algorithm. For example, in one embodiment, a risk profile matrix 380 shown in FIG. 8E may be used to determine a risk profile of the underlying subject matter (e.g., complaint, idea, suggestion) of the feedback ticket. The question manager may categorize (a) a business impact and (b) a risk for the feedback ticket, and apply these as inputs into risk profile matrix to determine a corresponding risk profile (low, medium, or high), from which an appropriate party for reviewing and approving the prepared answer. In one example implementation, the question manager may categorize the business impact and risk according to the following criteria:
low business impact=implementation costs <5,000 EUR
medium business impact=implementation costs between 5,000 EUR and 50,000 EUR
high business impact=implementation costs >50,000 EUR
low risk=changes within a process with minor consequences.
medium risk=changes within a process with crucial consequences or changes which influence different processes but only have a minor impact on these processes.
high risk=fundamental changes of several processes with crucial consequences.

The question manager then enters this data into compliance feedback tool 26, which determines the corresponding risk profile (low, medium, or high) for the ticket from risk profile matrix 380. An appropriate party for reviewing and approving the prepared answer is determined based on the determined risk profile. For example, as shown in FIG. 8E, for a low risk profile, the appropriate reviewing/approving party is the head of compliance helpdesk 12; for a medium risk profile, the appropriate reviewing/approving party is the head of compliance helpdesk 12 and the head of a compliance program group; and for a high risk profile, the appropriate reviewing/approving party is a designated improvement board. At step 340, the question manager forwards the ticket and prepared answer to the appropriate reviewing/approving party determined according to risk profile matrix 380 as described above.

At step 342, the reviewing/approving party that has received the ticket and prepared answer from the question manager then reviews and decides on the prepared answer. If the ticket has a low risk profile (determined as described above), the head of Compliance Helpdesk performs a technical and financial decision and sends the decision back to the question manager (indicated at step 344). A person responsible for implementation, the time schedule, and the budget may be approved.

If the ticket has a medium risk profile, the head of compliance helpdesk 12 and the head of a designated compliance program can make a decision, summon a “hot topic forum,” and/or escalate the ticket to an improvement board. In some embodiments, all fundamental feedback items are sent to the hot topic forum. The head of compliance helpdesk 12 and the head of a designated compliance program then sends the decision back to the question manager (indicated at step 344). A person responsible for implementation, the time schedule and the budget may be approved. The “hot topic forum” may be set-up as a platform for discussions and decisions regarding upcoming “hot” topics arising via compliance feedback tool 26 or brought up by the compliance community itself. The forum helps keep members of the compliance community updated (e.g., via forum conversations) and helps share the same regularly revised knowledge with every employee (e.g., via a ticker displayed to employees).

If the ticket has a high risk profile, an improvement board performs a technical and financial decision and sends the decision back to the question manager (indicated at step 344). A person responsible for implementation, the time schedule and the budget may be approved.

At step 346, the question manager then takes over the decision and includes the decision received by the reviewing/approving party into his or her answer at step 350. At step 354, the question manager may enter (e.g., select) ticket attributes and tags into tool 26. At step 356, the question manager may check the completeness of the feedback ticket, including verifying that an answer has been formulated, ticket attributes seven set, tagging has been carried out, and correct access rights have been given. If the ticket is not complete, indicated at 358, the method returns to step 324. If the ticket is complete, indicated at 360, the question manager may then route the ticket to the head of the compliance helpdesk 12 at step 362. The feedback ticket may be marked “ready for approval.” The head of the compliance helpdesk 12 may then approve the feedback ticket at step 364 if all criteria have been fulfilled. The approval may be sent to the submitter at step 366, and the status of the ticket changed to “solved.” If the head of the compliance helpdesk 12 does not approve the feedback ticket, the ticket may be routed back to the responsible question manager with a request to revise the answer.

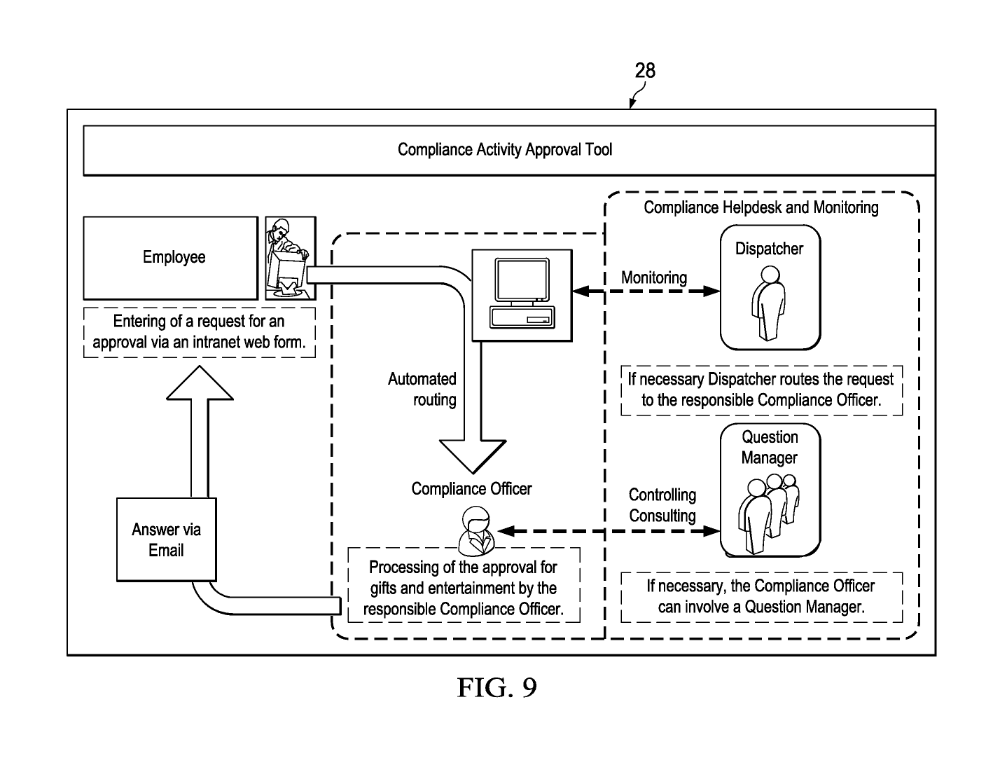

FIG. 9 illustrates an example process flow for compliance activity approval tool 28, according to certain embodiments of the present invention. Compliance activity approval tool 28 may be used for documenting and tracking activities (e.g., gifts, entertainment, and hospitalities) that require an approval by a compliance entity.

As shown in FIG. 9, the process may begin with an employee entering an approval request via an intranet web form provided by compliance helpdesk 12 at user device 14. A dispatcher of compliance helpdesk 12 may monitor received approval requests and route the request to a responsible compliance officer, if necessary. The compliance officer may analyze the request to determine whether to approve or deny the request, and provide an answer to the employee, e.g., by email. In some situations, the compliance officer may need to consult with compliance helpdesk 12 to analyze the request. For example, the compliance officer may consult with a question manager, who may in turn utilize additional human or electronic resources of compliance helpdesk 12. Compliance activity approval tool 28 may store relevant data regarding each approval request. In this manner, compliance activity approval tool 28 may provide central documentation for approval requests (e.g., gift, entertainment, and hospitality requests) and corresponding approval/denial decisions. In addition, compliance activity approval tool 28 may accelerate the approval process as compared to existing systems that are not centralized.

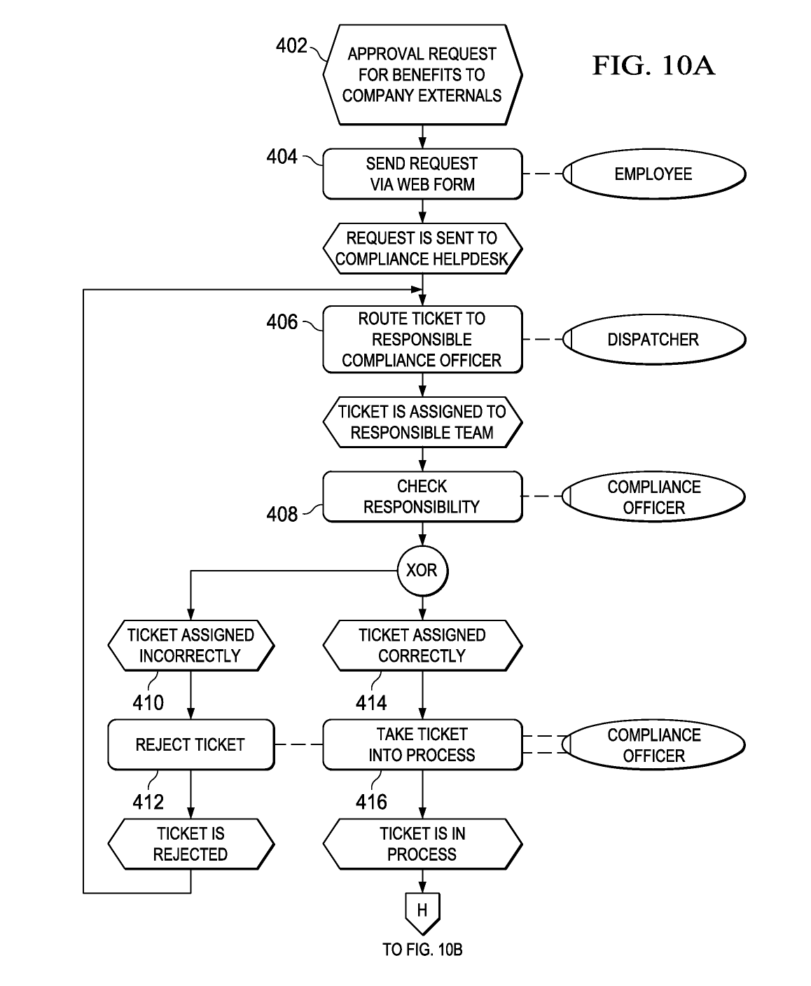

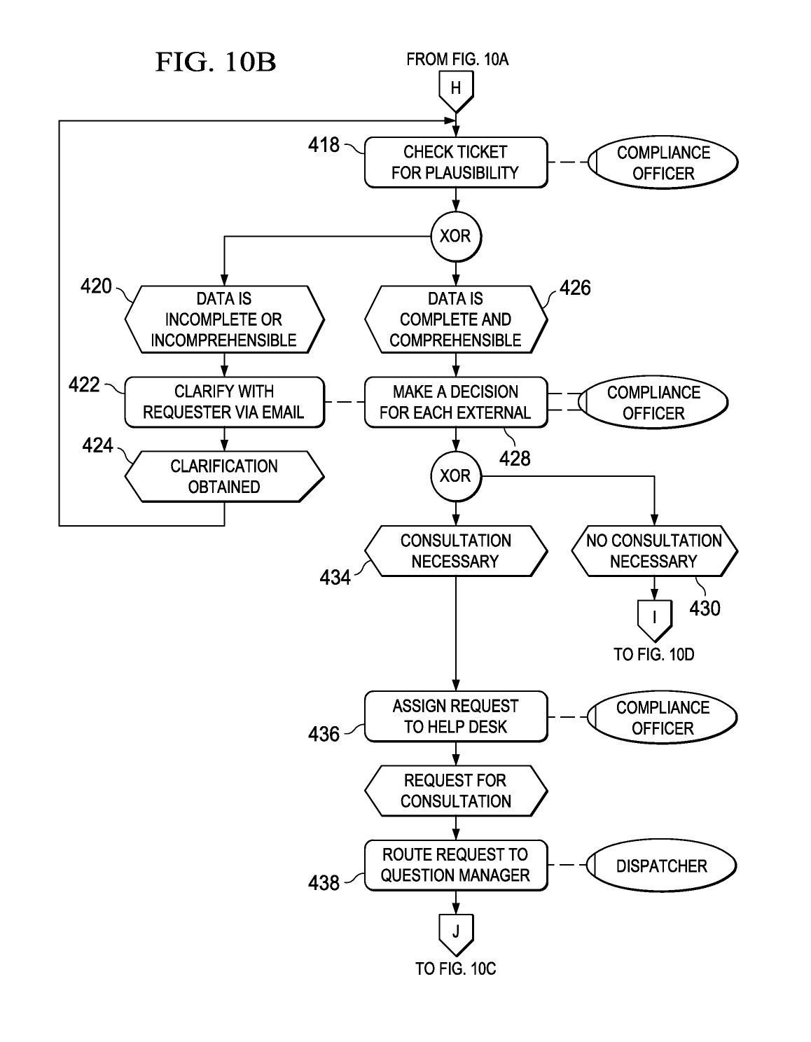

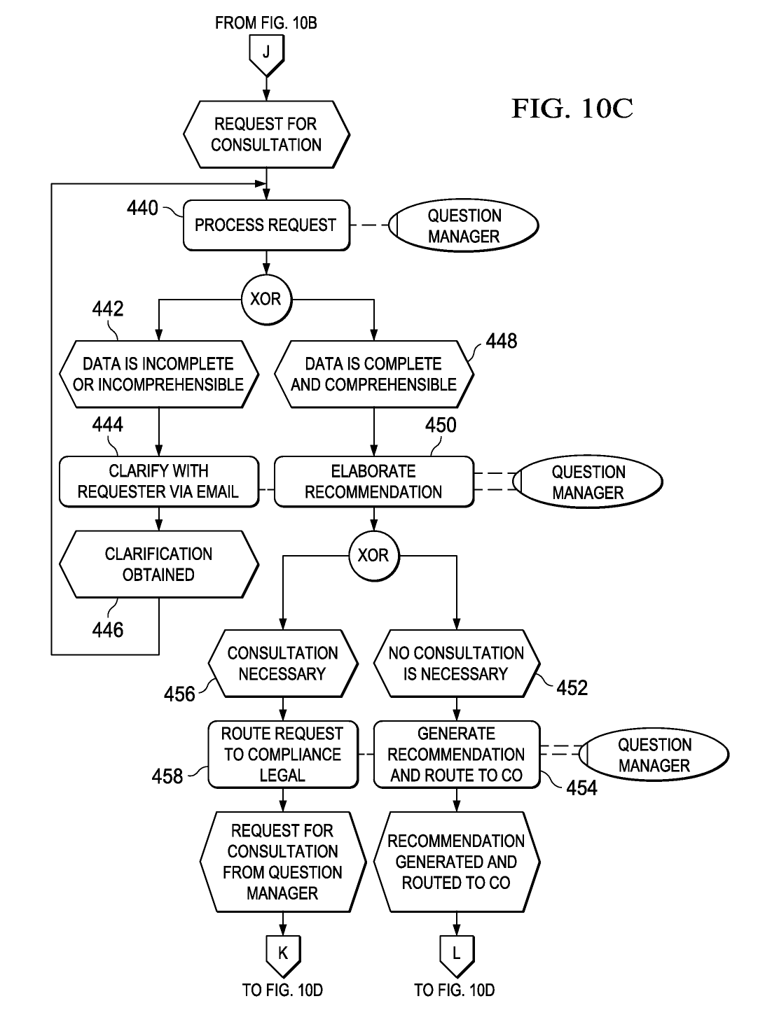

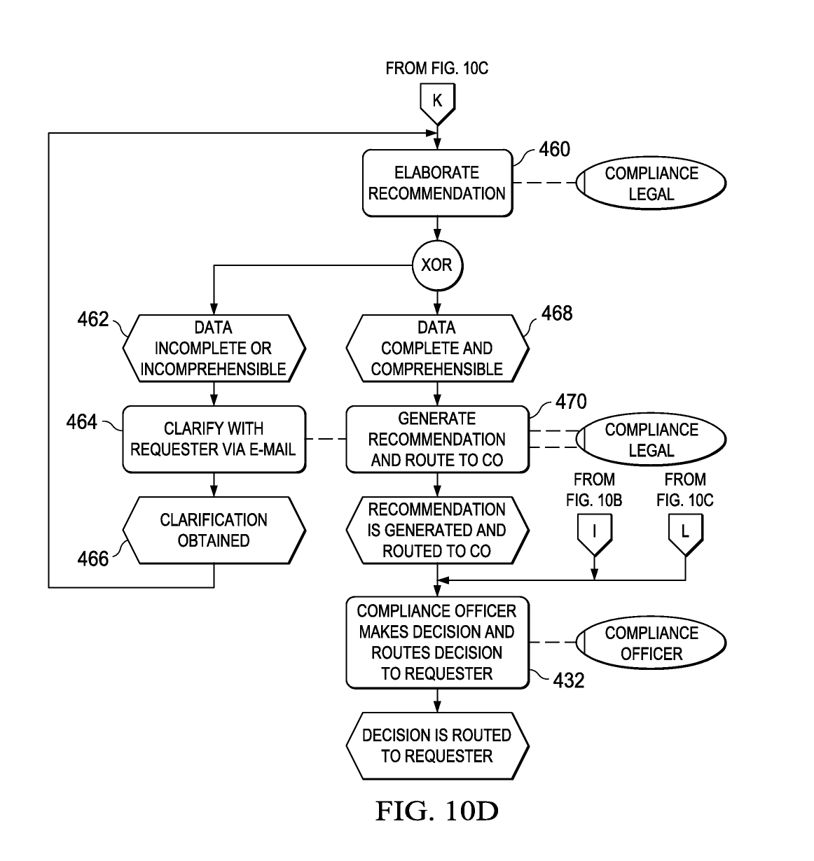

FIGS. 10A-10D illustrate a more detailed example of a compliance approval process flow 400 facilitated by compliance activity approval tool 28, according to certain embodiments of the present invention. FIGS. 10A-10D illustrate illustrates the various steps of process flow 400, as well as the person or entity that performs each step, as indicated in the ovals to the right of the process flow steps.

At step 402, an employee enters an approval request for benefits to a company external into an intranet page provided by tool 28. Such benefits may include, for example, gifts or hospitality items or activities to be provided to people or organizations outside of the business entity. In some embodiments, the data entered by the employee are treated as confidential and process under the terms of relevant data protection laws. At step 404, the employee (hereinafter referred to as the “requester”) submits the request such that a request ticket is forwarded via communication network 16 to compliance helpdesk 12.

At step 406, tool 28 automatically assigns the request ticket to a particular responsible compliance officer, based on the business group associated with the request. If no automatic assignment as possible, the request ticket is routed to a dispatcher, who routes it to the responsible compliance officer (e.g., based on the business group associated with the request). At step 408, after receiving the forwarded request ticket, the compliance officer checks whether he or she is responsible for the ticket. If the compliance officer determines that he or she is not responsible for the ticket, indicated at 410, the compliance officer may reject the ticket at step 412, and the ticket is automatically routed back to the dispatcher. If the compliance officer determines that he or she is responsible for the ticket, indicated at 414, the compliance officer accepts the tickets for processing at step 416.

At step 418, the compliance officer checks the plausibility and completeness of the entered data of the ticket. If the data is incomplete or incomprehensible, indicated at 420, the compliance officer may attempt to clarify the issue with the requester, e.g., via e-mail, at step 422. If a clarification is obtained at step 424, the method returns to step 418 to recheck the plausibility and completeness of the entered data of the ticket. If the data is complete and comprehensible, indicated at 426, the compliance officer may initiate a separate decision process for each external entity identified in the ticket, at step 428.

The compliance officer may then determine whether consultation is necessary for the approval decision process. If no consultation is necessary, indicated at 430, the compliance officer decides for each external if approval can be given, and routes the decision to the requester, at step 432. Alternatively, if consultation is necessary, indicated at 434, the compliance officer may elect to consult a question manager, indicated at 436. The request may then be automatically assigned to a dispatcher, who routes the request to an appropriate question manager at step 438.

At step 440, the question manager takes the ticket into process and checks if he or she can give advice, which may include checking the data in the ticket. If the data is incomplete or incomprehensible, indicated at 442, the question manager may attempt to clarify the issue with the requester, e.g., via e-mail, at step 444. If a clarification is obtained at step 446, the method returns to step 440 to recheck the plausibility and completeness of the entered data of the ticket. If the data is complete and comprehensible, indicated at 448, the question manager checks if he or she can make a recommendation regarding the ticket, at step 450.

The question manager may then determine whether consultation is necessary for the approval decision process. If no consultation is necessary, indicated at 452, the question manager makes a recommendation at step 454, which is automatically routed to the inquiring compliance officer. The compliance officer then decides, based on the question manager's recommendation, whether to approve each external benefit, and routes the decision to the requester, at step 432.

Alternatively, if consultation is necessary, indicated at 456, the question manager may route the request to a compliance legal entity (CLE) for consultation at step 458. At step 460, the CLE may then verify whether the information given in the request allows for a recommendation to be made. If the data is incomplete or incomprehensible, indicated at 462, the CLE may attempt to clarify the issue with the requester, e.g., via e-mail, at step 464. If a clarification is obtained at step 466, the method returns to step 460 to recheck the plausibility and completeness of the entered data of the ticket. If the data is complete and comprehensible, indicated at 468, the CLE makes a recommendation which is automatically sent to the inquiring compliance officer at step 470. The compliance officer then decides, based on the CLE's recommendation, whether to approve each external benefit, and routes the decision to the requester, at step 432.

It will be appreciated that systems, methods, and techniques disclosed herein may be similarly applied in other contexts. Additionally, it should be understood that various changes, substitutions and alterations can be made herein without departing from the spirit and scope of the disclosure as illustrated by the following claims.

What is claimed is:

1. A system for providing compliance functions in a business entity, comprising:
a computer-implemented compliance question-answer tool configured to receive compliance related questions from a plurality of users and, in response, provide compliance related advice to the users;
a computer-implemented compliance knowledge database tool including a database of compliance related data and a user interface allowing the users to search the database of compliance related data; and
a computer-implemented user feedback tool including a user interface allowing the users to provide compliance related feedback to the business entity.

2. A system according to claim 1, further comprising a computer-implemented whistleblower tool including a user interface allowing the users to report potential compliance violations.

3. A system according to claim 1, further comprising a computer-implemented compliance activity approval tool configured to document and track activities that require an approval by a compliance entity.

4. A system according to claim 1, wherein the compliance question-answer tool is configured to:
receive a plurality of compliance related questions from a plurality of users;
route each received compliance related question to an appropriate subject matter expert based on the content of each question;
receive a response to each question from the appropriate subject matter experts; and
forward each response back to the appropriate user.

5. A system according to claim 4, wherein routing each received compliance related question to an appropriate subject matter expert based on the content of each question includes:
a dispatcher receiving a plurality of questions from the users;
the dispatcher forwarding each question to one of a plurality of question managers based on the content of the question; and
each question manager forwarding each question received from the dispatcher to one of a plurality of subject matter experts based on the content of the question.

6. A system according to claim 1, wherein the compliance knowledge database tool includes:
a public database portion including compliance related data accessible to all users of the system; and
a restricted database portion including compliance related data accessible only to a set of authorized compliance experts.

7. A computer facilitated method for providing compliance functions in a business entity, comprising:
receiving a question from a requester via a communications network;
generating a ticket for the question;
routing the ticket to a question manager;
the question manager reviewing the ticket and determining whether one or more subject matter experts need to be consulted for answering the question;
at least one of the question manager and one or more subject matter experts preparing an answer to the question;
approving the prepared answer; and
forwarding the approved answer to the requester.

8. A method according to claim 7, wherein the question is received via a web-based form completed by the requester.

9. A method according to claim 7, further comprising assigning reading access for accessing the ticket.

10. A method according to claim 7, further comprising selecting the question manager to route the ticket to based on one or more attributes of the ticket.

11. A method according to claim 7, further comprising the question manager consulting a knowledge database for an answer to the question before determining whether one or more subject matter experts need to be consulted for answering the question.

12. A method according to claim 7, further comprising receiving answer portions from multiple subject matter experts and consolidating the answer portions to prepare an answer to the question.

13. A method according to claim 7, further comprising forwarding the prepared answer to a compliance legal entity for approval.

14. A computer facilitated method for providing compliance related feedback to a business entity, comprising:
receiving a feedback item from a submitter via a communications network;
generating a ticket for the feedback item;
routing the ticket to a question manager;
the question manager reviewing the ticket and determining whether one or more subject matter experts need to be consulted for preparing an answer;
at least one of the question manager and one or more subject matter experts preparing an answer;
determining a risk profile for the ticket;
automatically determining an appropriate party for reviewing the prepared answer;
approving the prepared answer; and
forwarding the approved answer to the submitter.

15. A method according to claim 14, wherein the feedback item is received via a web-based form completed by the submitter.

16. A method according to claim 14, further comprising assigning reading access for accessing the ticket.

17. A method according to claim 14, further comprising selecting the question manager to route the ticket to based on one or more attributes of the ticket.

18. A method according to claim 14, wherein determining a risk profile for the ticket comprises using a risk profile matrix or algorithm to determine a risk profile based on a business impact rating and a risk rating.

19. A method according to claim 14, wherein determining a risk profile for the ticket comprises using a risk profile matrix or algorithm to determine a risk profile based on a business impact rating and a risk rating.

20. A method according to claim 14, further comprising receiving answer portions from multiple subject matter experts and consolidating the answer portions to prepare an answer.
